(19) United States
(12) Patent Application Publication
(10) Pub. No.: US 2004/0213641 A1
(43) Pub. Date: Oct. 28, 2004

(54) Device for diamond hollow drills

(76) Inventor: Horst Karl Schraml, Grossraming (AT)

Correspondence Address: WILLIAM COLLARD, COLLARD & ROE, P.C., 1077 NORTHERN BOULEVARD, ROSLYN, NY, 11576, US

(21) Appl. No.: 10/275,627

(22) PCT Filed: Mar. 5, 2002
(86) PCT No.: PCT/AT02/00068

(51) Int. Cl. B23B 51/00

(52) U.S. Cl. 408/226; 408/238

(57) ABSTRACT

With respect to a device on diamond hollow drills, the actual component (4, 8) of the drill (1) that forms the coupling to the clamping device of a drilling machine or an additional component that has a clamping device for the drill and a holder for coupling to the clamping device is developed as an adapter that can be adjusted and fixed in position with respect to its length.

A rapid-action coupling for connecting the drill to a drilling machine and a device for adjusting the overall length of the drill unit are disclosed.

### FIELD OF INVENTION

Diamond hollow drills are employed on drilling machines in the glass, masonry and ceramics processing industries for producing cylindrical or cone-shaped holes or holes that combine these two forms. The crown of these drills has a sintered diamond coating, e.g. 10 mm in length, and is subject to wear, making it necessary to continually readjust the drill itself or also the drilling machine control equipment, depending upon the extent of wear. Bores of different diameters produce different loads and therefore result in different wear characteristics. Consequently, in practice it is necessary to readjust the drilling machine controls to the actual length of the drill every time a different drill is fitted.

### BACKGROUND ART

Reference must be made to the fact that various adapters are already being employed for diamond hollow drills and machine tools. EP 0604362 A discloses a hollow drill crown with an internally threaded hole, whereby the crown is firmly attached to the mating surface of the adapter when the end face of the crown abuts against said mating surface by means of a threaded bolt projecting from the adapter, with both threads having different nominal diameters such that pockets are formed between them for collecting contamination so that nothing hinders the drill crown from being released from the adapter.

DE 3446296 A makes known a hollow drill for drilling through GRP laminates whereby provision is made in the outer casing of the body of the crown for helical slits that originate at the crown. An outer collar extends around the external surface of the body of the crown, forming a tapered groove between said collar and the cylindrical surface of the body of the crown into which a cone is inserted to adjust the diameter drilled by narrowing or widening the slits.

Finally, GB 2198374 A makes known a shaft or a similar component mounted in an adapter and aligned axially with a drive shaft, whereby it is possible to preset the depth that the shaft can be inserted into the adapter cavity by means of a set screw before the adapter is slightly tilted in the bearing by means of radially acting screws, thereby bringing it into a coaxial position with respect to the drive shaft.

### DISCLOSURE OF THE INVENTION

The primary objective of the invention is to create a simple device that makes it possible to set and/or readjust diamond hollow drills quickly and accurately, without having to manipulate the machine controls or rechuck the drill. Secondary objectives of the invention are to disclose auxiliary devices that allow retooling to be accelerated, operational drill settings to be simplified, and length adjustments to be automated.

The primary objective is fulfilled by means of a device as provided for in accordance with Claim 1.

The working distance of the tip of the drill from the clamping device is set or reset precisely by means of the aforementioned length adjustments that take actual wear into account. Specific aspects of the inventive idea can be achieved in various ways.

Employing the currently preferred embodiment in accordance with Claim 2 and subject to the structural design of the existing drilling machine, it is possible to fit a drill which has an externally threaded shank with an adapter with an external thread, which for instance can be screwed into the standard rotary sleeve joint forming the tool holder of an appropriate drilling machine or to prepare the same drill for connection to the drilling machine using a rapid action coupling.

If the adapter is essentially a component of the drill itself, the length can be set by adjusting the screw of the drill itself along the internal thread of the sleeve. In the case of an adapter that can be used with any standard drill, an embodiment in accordance with Claim 3 is preferred.

Care is taken in each case to ensure that the adjusted length does not change during drilling. A simple and effective measure is found in the embodiment in accordance with Claim 4.

An embodiment in accordance with Claim 5 can be selected to ensure that the drill equipped with the adapter is adequately guided and balanced.

An embodiment in accordance with Claim 6 prevents corrosion of the adjusting thread resulting from the effect of cooling or flushing fluids flowing through the hollow drill.

An embodiment in accordance with Claim 7 allows for especially rapid retooling, with the same overall adapter/drill unit lengths being set, so that changes to the settings and/or allowances for varying lengths with respect to the drilling machine are unnecessary. The clamping parts can make such a noise when they lock into place so that the operator is easily able to assess whether coupling has occurred properly. The rapid coupling for which provision is made could also be used for diamond hollow drills and also for other drilling and grinding tools, albeit without enjoying the advantages of the exact preset length of the installed part.

Finally, it is also possible to make provision for the components of the quick-action coupling on the drill side to be located directly on the accordingly designed drill, and not on an adapter.

Adjustment of the drilling tool employed is facilitated by an embodiment in accordance with Claim 8. Preferably, an embodiment in accordance with Claim 9 would be selected that permits the coupling to the drilling machine to be engaged or disengaged in a manner similar to that employed in quick-release hose couplings.

In order to fully utilize the advantages provided by the adjustment options for the length of the drill during normal operation, it is recommended that the drill/adapter units in stock be set to the exact total length and that the drill/adapter units are also set to the exact total length after every use or following any possible wear. In this case the invention preferably provides for an auxiliary device in accordance with Claim 10. In the simplest case, the swivel support, holder and limit stop are operated by hand. In order to execute the setting procedure as quickly and precisely as possible, even by trained assistants, provision is made for the auxiliary device to be developed in accordance with Claim 11.

Many of the procedures that were necessary in the past during drilling are no longer required as a consequence of being able to set the exact lengths for the drill/adapter unit, thereby providing for precise chucking. For instance, it is no longer necessary to touch the surface of the workpiece with the drill after retooling and to readjust the settings made for the first tool after the actual value for the total length has been determined. It is far simpler to set the drill depth setting immediately on the basis of drilling depth stops that are calibrated once to the constant tool length and then set to the drilling depth. It is recommended that one uses the workpiece surface on the drill side as the counter stop for such drilling depth stops or also another surface, e.g. the upper surface of the clamp for a glass plate which has a clearly defined distance from the surface of the workpiece during operation.

### SHORT DESCRIPTION OF DRAWING

Further details and advantages of the subject matter of the invention can be found in the following description of the drawing.

The subject matter of the invention is shown in exemplary embodiments in the drawing.

FIG. 1 shows a partial cross-section and partial side view of a diamond hollow drill fitted with an adapter,

FIG. 2 shows an adapter specifically designed as a special component for connecting to a series-manufactured diamond hollow drill in the same view as FIG. 1,

FIG. 3 shows an exploded view in partial section of a diamond hollow drill similar in design to FIG. 1, the adapter of which forms part of a push-fit coupling with the corresponding chuck and the end of the spindle of the drilling machine,

FIG. 4 shows a length-setting device designed specifically for manual operation in partial diagrammatic view,

FIG. 5 shows a length-setting device designed specifically for automatic operation in a similar representation, also in diagrammatic view.

### DESCRIPTION OF EMBODIMENTS OF THE INVENTION

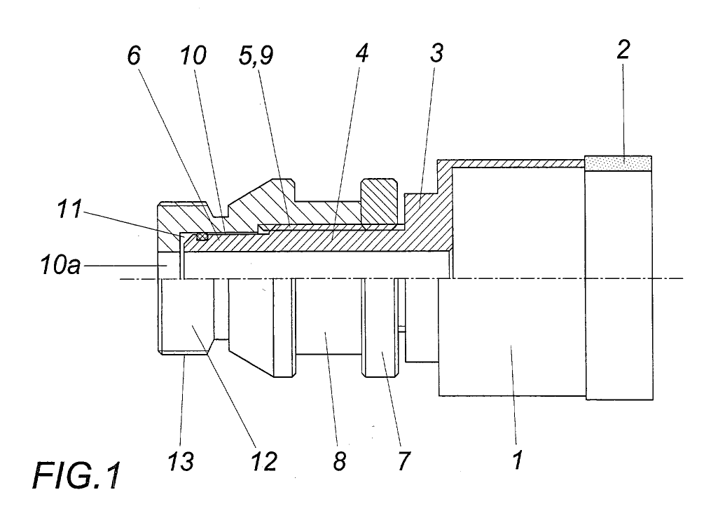

In accordance with FIG. 1 the diamond hollow drill has a cutting head 1 with a sintered diamond coating 2. The hollow cutting head 1 extends axially in a longitudinal direction and then forms a downward step 3, after which it forms a hollow threaded shank 4 with an external thread 5, forming an extension 6 from the point where the said external thread 5 ends. Screwed one after the other onto the thread 5 are a locknut 7 and a sleeve 8 provided with an internal thread 9 and an axially extending hole 10 for accommodating the centering extension 6. The open end of the hole 10 is provided with a shoulder in section 10a and serves to support a seal 11. Section 12 of the sleeve 8 has an external thread 13 that can be utilised for connecting the drilling machine, for instance by employing its standard rotary joint. Instead of having threaded ends 12, 13, provision can also be made for a rapid-action coupling projection for other drilling machines accordingly. When the length needs to be reset as a consequence of the diamond coating 2 becoming worn, the locknut 7 is initially loosened and then the cutting head is rotated until the required readjustment has been made by means of the threads 5, 9. The locknut 7 is then retightened. This locknut 7 can be embodied as a polygonal nut in order to facilitate handling, with recesses for holding a ring spanner, or also have a non-slip surface by virtue of ribbing or something similar.

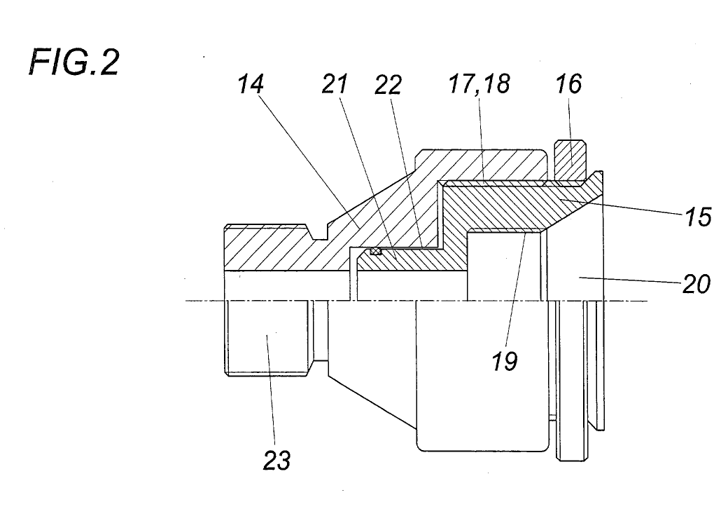

The adapter in accordance with FIG. 2 has a sleeve consisting of an outer part 14 and an inner part 15 and a locknut 16. The outer part 14 and the inner part 15 are provided with the adjusting thread 17, 18, upon which the locknut 16 also travels. The inner part 15 has an internal thread 19 for screwing on the threaded shank of a commercially available diamond hollow drill. Moreover, with respect to this hollow drill provision is made for mating surfaces 20 to act as supports. In order to increase stability the inner part 15 is elongated to form a guide extension 21, which is inserted into the guide hole 22 that corresponds to the hole 10 in accordance with FIG. 1. A threaded end 23 of the outer part 14 of the sleeve fulfils its function against the end 12 of the part in accordance with FIG. 1 and can be replaced, as suggested in that case, with a rapid-action coupling projection.

In addition to the embodiments of the adapter described in the examples, embodiments are also possible within the scope of the invention that provide for a steep-pitch thread for adjusting the length. It is also possible to employ, for instance, simple telescopic sliding guides with locking devices.

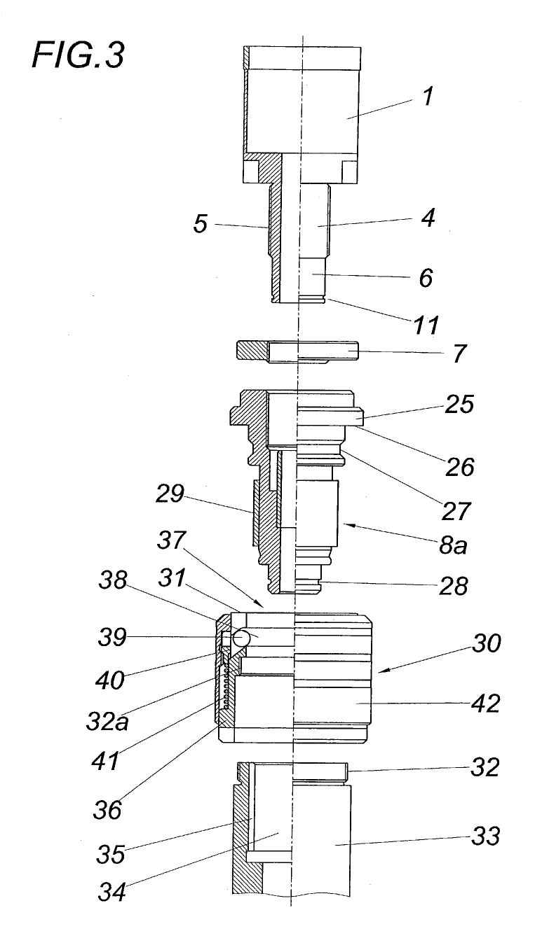

The embodiment in accordance with FIG. 3 employs a slightly modified adapter 8a that has a collar 25 for facilitating handling, the rear side of which forms a mating surface 26, and at a minimal axial distance from said collar 25 the adapter 8a also has a annular groove 27. The adapter end also has a annular groove 28 for the insertion of a seal. Moreover, the extended shank is also fitted with at least one key or tapered key 29. The adapter 8a is fitted into a drill chuck 30 all the way to the limit stop 26, with the end face 31 of the drill chuck 30 forming a mating limit surface for the mating surface 26. This chuck is screwed onto the threaded end 32 of a spindle 33 of a drilling machine by means of the internal thread 32a, whereby provision is made in the spindle opening 34 for at least one keyway 35 for engaging the key 29 or a corresponding taper key.

The chuck 30 itself has an inner part 36 in the form of a sleeve with a socket-type opening 37 for inserting the adapter 8a. Said sleeve has guides and holders 38 for clamps, consisting in the exemplary embodiment of steel springs 39. Said clamps can be adjusted along the inclined guide surfaces, project into the opening 37 as a result of their inherent tension, and lock into place in the annular groove 27 when the adapter 8a is inserted. A lock ring 40 runs along the outside of the sleeve 36, whereby said lock ring is subject to the pressure of a biased compression spring 41 that has the tendency to push said ring over the clamps 39, locking these clamps into position for holding the adapter 8a. The drawing shows a position in which the ring 40 is slightly retracted. This retracted position is normally achieved simply by sliding an outer sleeve 42 that forms a handle in the direction of the spindle 33, whereby it transports the ring 40 with it, releasing the clamps 39.The effort required to use the drill is therefore limited to inserting the adapter 8a coupled to the drill 1 when the outer sleeve 42 is retracted, with the clamps 39 engaging in the annular groove 27 and being secured by the ring 40, which is pushed back into the working position together with the outer sleeve 42 by the spring 41.

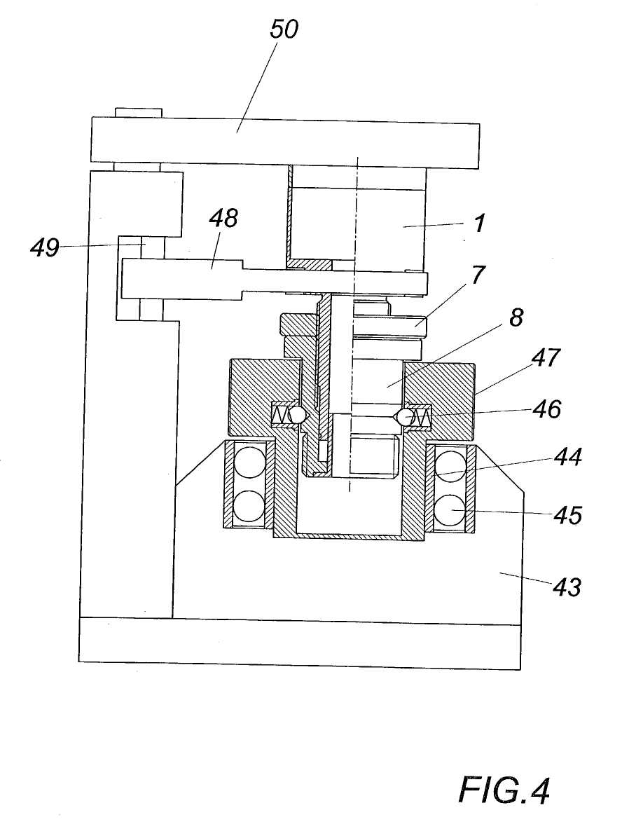

The auxiliary device in accordance with FIG. 4 has a basic frame 43 on which a swivel support 44 is mounted with the aid of ball bearings 45, whereby said swivel support 44 has spring-loaded retainers 46 which engage in this case with the corresponding lock notches provided in the shank of the adapter 8, actuating this adapter 8 of the drill 1 being employed when the knurled collar 47 is set in rotation. In addition, a clamp-type tool holder 48 is mounted on the machine frame that prevents the cutting crown 1 from rotating in the clamped position, but which can be adjusted in terms of height along a guide 49. After the drill-unit 1, 8 has been positioned, the locknut 7 is loosened first and then a fixed limit stop 50 for setting the specified length is swivelled over the drill 1. Then, by rotating component 44 the adapter is rotated, with the specified length being set as a result of the interaction between the threads of the drill 1 and the adapter 8 until the limit stop 50 is reached.

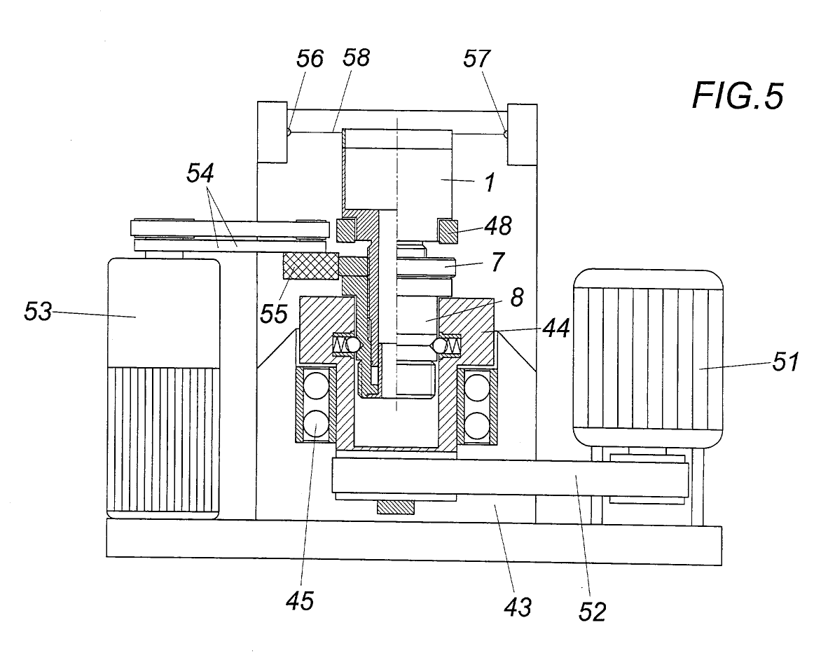

The embodiment in accordance with FIG. 5 differs from that in accordance with FIG. 4 by virtue of the fact that provision is made for motorised drives for actuating various components of the mechanisms mounted on the machine frame 43. For instance, provision is made for a motor 51 with a belt drive 52 for driving the swivel support 44. The clamp-type tool holder 48 is also fitted with its own drive unit (not shown) and another motor 53 drives a friction drive roller 55 via a belt drive 54 that can be swivelled in and out for loosening and tightening the locknut 7. The fixed limit stop 50 in accordance with FIG. 4 is replaced by at least one photoelectric barrier 58 comprising a transmitter 56 and a receiver 57. After the drill unit 1, 8 has been positioned in the swivel support 44, the locknut 7 is loosened by means of a secondary control to actuate the friction drive roller 55 and to actuate the clamp-type tool holder 48 simultaneously or prior to actuating said roller. The actuating connection between the friction drive roller 55 and the locknut 7 is disengaged and the swivel support 44 is driven by the motor 51. If the photoelectric barrier 58 is interrupted while the unit is being switched on, the drill 1 is repositioned in the adapter 8. When the photoelectric barrier 58 is unobstructed, the swivel support 44 is driven in the opposite direction of rotation and the drill 1 is disconnected until the photoelectric barrier 58 is interrupted. As soon as the end of the drill I and the photoelectric barrier 58 are aligned, actuation by means of 51, 52 is interrupted, after which the locknut 7 is tightened in the opposite direction by means of the friction drive roller 55 and then the friction drive roller 55 and the clamp-type toll holder 48 are swung out such that the calibrated drill unit can be removed. The control device was not shown in FIG. 5 as its function is apparent from the previous description.

1. Device on diamond hollow drills wherein the component (4, 8, 8a) of the drill (1) itself that forms the coupling to the clamping device (30) of a drilling machine or an additional component (14, 15) that has a clamping device (15, 19) for the drill (1) and a holder (23, 27, 29) for coupling to the clamping device is developed as an adapter that can be adjusted and fixed in position with respect to its length.

2. Device in accordance with claim 1 wherein the adapter is a collar or sleeve (8, 8a) with an internal thread (9) for accommodating a drill shank (4) with an external thread (5) and with a holder (12, 27, 29) in the form of an external thread or part of a rapid-action coupling (30) for coupling to a clamping device (30, 33).

3. Device in accordance with claims 1 and 2 wherein the sleeve (14, 15) forming the adapter is developed in two parts, whereby the inner part (15) has the internal thread (19) for screwing in the drill shank, provision is made on the outer part (14) for a holder (23) for coupling to the clamping device of the drilling machine, and the inner part (15) can be screwed into the outer part (14) for the purpose of setting the length.

4. Device in accordance with the claims 1 to 3 wherein provision is made for a locknut (7, 16) that can be screwed onto the outer thread (5, 17) of the drill shank (4) or of the inner part (15) of the two-piece sleeve (14, 15) for securing the length setting.

5. Device in accordance with any one of the claims 1 to 4 wherein the end (6) of the drill shank (4) facing away from the cutting crown (2) or the corresponding end (21) of the inner part (15) of the sleeve (14, 15) extends past the thread (18) and engages with a guide and centring hole(10, 22) of the sleeve (8, 8a) or of the outer part (14) of the sleeve (14, 15).

6. Device in accordance with claim 5 wherein a seal (11) is arranged between the elongated end (6, 21) of the drill shank (4) or of the inner part (15) of the sleeve (14, 15) and the guide hole (10, 22).

7. Device in accordance with any one of the claims 1 to 6 wherein a rapid-action coupling for the adapter (8a) is developed as a plug-and-socket-type coupling, whereby a drill chuck (30) mounted on the hollow spindle (33) of the drilling machine has clamps (39) constituting a longitudinal retaining device, wherein said clamps (39) can be released into the socket-type opening (37) for the adapter (8a), clip into a mating groove (27) or mating channel of the adapter (8a), and are securable by means of a sliding sleeve (40) in the arrested position and wherein the adapter (8a) can be connected to the spindle (33) for the purpose of imparting rotational actuation by means of a keyway, key or tapered key joints (21, 35).

8. Device in accordance with claim 7 wherein the drill chuck (30) has a mating surface (31) on the end face for a corresponding limit stop on the adapter (8a) in the form of a mating surface (26).

9. Device in accordance with either claim 7 or 8 wherein the sliding sleeve (40, 42) is biased by means of springs (41) in the locking direction of the clamps (39) that are for instance formed by steel springs.

10. Auxiliary device for an apparatus in accordance with claims 1 to 6 wherein it is developed as a length adjustment device that has a swivel support (44) that can be coupled with the adapter (8) for driving it rotationally, a holder (48) that can be adjusted longitudinally in relation to said swivel support with the drill (1) held in place by said swivel support, and a limit stop determining the extent of the adjustment, e.g. a fixed limit stop (50) or a photoelectric barrier (58) (FIG. 4 and 5).

11. Auxiliary device in accordance with claim 10 wherein for the purpose of automating the adjustment procedure, provision is made for auxiliary drives (51-55) for the purpose of rotationally actuating the swivel support (44), for loosening and/or tightening the locknut (7) and for tightening or loosening the drill holder (48), whereby a control unit controls the auxiliary drives (50-55), interrupts the longitudinal adjustment when the limit stop (58) is reached, and then secures the setting, for instance by tightening the locknut (7).
